(19) United States
(12) Patent Application Publication
(10) Pub. No.: US 2023/0410008 A1
(43) Pub. Date: Dec. 21, 2023

(54) TASK EDITOR FOR CUSTOM ENTERPRISE TASKS

(71) Applicant: SAP SE, Walldorf (DE)

(72) Inventors: Nathan Bienfait, Paris (FR); Kevin Le Fur, Paris (FR); Jonathan Rakotovao, Paris (FR); Alexandre Fortin, Paris (FR); Xiaohui Xue, Courbevoie (FR); Didier Bolf, Issy Les Moulineaux (FR)

(21) Appl. No.: 17/842,591

(22) Filed: Jun. 16, 2022

(51) Int. Cl. G06Q 10/06

(52) U.S. Cl. CPC G06Q 10/06316; G06F 3/04847

(57) ABSTRACT

A method may include generating, for display at a client device, a user interface for creating and configuring a custom task associated with one or more enterprise software applications. The user interface may display a plurality of components. The custom task may be configurable by adding one or more components to the custom task, reordering the one or more components, configuring a property of the one or more components, and/or deleting the one or more components from the custom task. One or more user inputs configuring the custom task may be received through the user interface. The custom task may be generated based on the one or more user inputs for subsequent execution. Related systems and computer program products are also provided.

### FIELD

The present disclosure generally relates to enterprise software applications and more specifically to custom tasks for enterprise software applications.

### BACKGROUND

An enterprise may rely on a suite of enterprise software applications for sourcing, procurement, supply chain management, invoicing, and payment. These enterprise software applications may provide a variety of data processing functionalities including, for example, billing, invoicing, procurement, payroll, time and attendance management, recruiting and onboarding, learning and development, performance and compensation, workforce planning, and/or the like. Data associated with multiple enterprise software applications may be stored in a common database in order to enable a seamless integration between different enterprise software applications. For example, an enterprise resource planning (ERP) application may track resources, such as cash, raw materials, and production capacity, and the status of various commitments such as purchase order and payroll. In the event the enterprise interacts with large and evolving roster of external vendors, the enterprise resource planning (ERP) application may be integrated with a supplier lifecycle management (SLM) application configured to perform one or more of supplier identification, selection and segmentation, onboarding, performance management, information management, risk management, relationship management, and offboarding.

### SUMMARY

Methods, systems, and articles of manufacture, including computer program products, are provided for a custom task. In one aspect, there is provided a system. The system may include at least one data processor and at least one memory. The at least one memory may store instructions that result in operations when executed by the at least one data processor. The operations may include: generating, for display at a client device, a user interface for creating and configuring a custom task associated with one or more enterprise software applications, the user interface displaying a plurality of components, and the custom task being configurable by adding one or more components to the custom task, reordering the one or more components, configuring a property of the one or more components, and/or deleting the one or more components from the custom task; receiving, through the user interface, one or more user inputs configuring the custom task; and generating, based on the one or more user inputs, the custom task for subsequent execution.

In another aspect, there is provided a method for a custom task. The method may include: generating, for display at a client device, a user interface for creating and configuring a custom task associated with one or more enterprise software applications, the user interface displaying a plurality of components, and the custom task being configurable by adding one or more components to the custom task, reordering the one or more components, configuring a property of the one or more components, and/or deleting the one or more components from the custom task; receiving, through the user interface, one or more user inputs configuring the custom task; and generating, based on the one or more user inputs, the custom task for subsequent execution.

In another aspect, there is provided a computer program product that includes a non-transitory computer readable storage medium. The non-transitory computer-readable storage medium may include program code that causes operations when executed by at least one data processor. The operations may include: generating, for display at a client device, a user interface for creating and configuring a custom task associated with one or more enterprise software applications, the user interface displaying a plurality of components, and the custom task being configurable by adding one or more components to the custom task, reordering the one or more components, configuring a property of the one or more components, and/or deleting the one or more components from the custom task; receiving, through the user interface, one or more user inputs configuring the custom task; and generating, based on the one or more user inputs, the custom task for subsequent execution.

In some variations of the methods, systems, and non-transitory computer readable media, one or more of the following features can optionally be included in any feasible combination. The custom task may include a sequence of actions corresponding to the one or more components added to the custom task. Each action in the sequence of actions may be associated with one or more inputs and/or outputs.

In some variations, at least one input or output of the one or more inputs and/or outputs may be defined as a fixed value.

In some variations, at least one input or output of the one or more inputs and/or outputs may be defined as a variable.

In some variations, the variable may be associated with a value that is provided during an execution of the custom task.

In some variations, the user interface may be updated to support creating and configuring a form for soliciting one or more user inputs specifying the value of the variable during the execution of the custom task.

In some variations, the user interface may be updated to support creating and configuring an automation or process. A first user input creating the automation or process may be received through the updated user interface. The automation or process including the custom task may be generated based at least on the first user input and the second user input.

In some variations, a third user input adding one or more activities to the automation or process including the custom task may be received through the updated user interface. The automation or process may be generated, based at least on the third user input, to include the custom task as well as the one or more activities.

In some variations, the one or more activities may include a log message activity for displaying an output of the custom task.

In some variations, the generating of the custom task may include generating a corresponding custom task object having an Extensible Markup Language (XML) view and one or more bindings.

In some variations, the custom task may be configured by at least modifying the Extensible Markup Language (XML) view of the custom task.

In some variations, the one or more bindings may be created in response to a component in the custom task being linked to a variable input or a variable output.

Implementations of the current subject matter can include methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including, for example, to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to enterprise software applications, it should be readily understood that such features are not intended to be limiting. The claims that follow this disclosure are intended to define the scope of the protected subject matter.

### DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts a system diagram illustrating an enterprise software system, in accordance with some example embodiments;

FIG. 2A depicts a screenshot illustrating an example of a user interface for creating a custom task, in accordance with some example embodiments;

FIG. 2B depicts a screenshot illustrating another example of a user interface for creating a custom task, in accordance with some example embodiments;

FIG. 2C depicts a screenshot illustrating another example of a user interface for creating a custom task, in accordance with some example embodiments;

FIG. 2D depicts a screenshot illustrating another example of a user interface for creating a custom task, in accordance with some example embodiments;

FIG. 2E depicts a screenshot illustrating another example of a user interface for creating a custom task, in accordance with some example embodiments;

FIG. 2F depicts a screenshot illustrating another example of a user interface for creating a custom task, in accordance with some example embodiments;

FIG. 2G depicts a screenshot illustrating another example of a user interface for creating a custom task, in accordance with some example embodiments;

FIG. 2H depicts a screenshot illustrating another example of a user interface for creating a custom task, in accordance with some example embodiments;

FIG. 2I depicts a screenshot illustrating another example of a user interface for creating a custom task, in accordance with some example embodiments;

FIG. 3 depicts a screenshot illustrating an example of a user interface for invoking a custom task, in accordance with some example embodiments;

FIG. 4A depicts a flowchart illustrating an example of a process for creating a custom task, in accordance with some example embodiments;

FIG. 4B depicts a flowchart illustrating another example of a process for creating a custom task, in accordance with some example embodiments; and

FIG. 5 depicts a block diagram illustrating an example of a computing system, in accordance with some example embodiments.

When practical, like labels are used to refer to same or similar items in the drawings.

### DETAILED DESCRIPTION

Enterprise software applications may provide a variety of solutions for sourcing, procurement, supply chain management, invoicing, and payment. For example, the software application may perform various data processing functionalities such as billing, invoicing, procurement, payroll, time and attendance management, recruiting and onboarding, learning and development, performance and compensation, workforce planning, and logistics. Nevertheless, many of the operations performed using enterprise software applications are tedious and time consuming. For instance, the creation of a large quantity of similar data objects, such as purchase orders, can be a repetitive and protracted operation. Conventional solutions for creating custom tasks to automate such operations are convoluted and require significant programming expertise, thus preventing more widespread adoption of custom tasks. As such, in some example embodiments, a task editor may be configured to support the creation of custom tasks with minimal requirement for coding. The task editor may provide an interactive user interface in which a custom task is created by adding one or more components to the task, reordering the one or more components, configuring the properties of the one or more components, and/or deleting the one or more components.

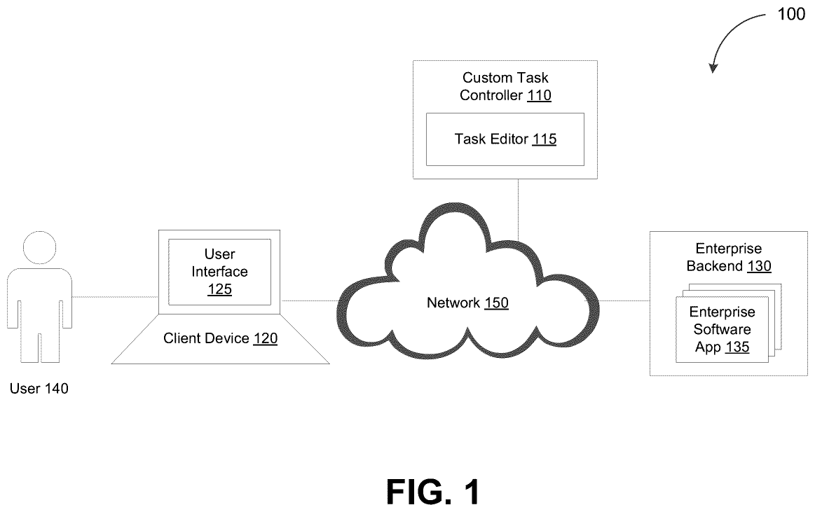

FIG. 1 depicts a system diagram illustrating an example of an enterprise software system 100, in accordance with some example embodiments. Referring to FIG. 1, the enterprise software system 100 may include a custom task controller 110, a client device 120, and an enterprise backend 130 hosting one or more enterprise software applications 135. The custom task controller 110, the client device 120, and the enterprise backend 130 may be communicatively coupled via a network 150. The client device 120 may be a processor-based device including, for example, a smartphone, a tablet computer, a wearable apparatus, a virtual assistant, an Internet-of-Things (IoT) appliance, and/or the like. The network 150 may be a wired network and/or a wireless network including, for example, a wide area network (WAN), a local area network (LAN), a virtual local area network (VLAN), a public land mobile network (PLMN), the Internet, and/or the like.

In some example embodiments, the custom task controller 110 may include a task editor 115 configured to support the creation of a custom task associated with the one or more enterprise software applications 135 hosted at the enterprise backend 130. The custom task may be configured, for example, based on one or more user inputs received through a user interface 125 associated with the task editor 115, to perform various tasks associated with the one or more enterprise software applications 135 including, for example, billing, invoicing, procurement, payroll, time and attendance management, recruiting and onboarding, learning and development, performance and compensation, workforce planning, logistics, and/or the like. In particular, the custom task may be configured to perform repetitive and time consuming tasks, such as the creation of a large quantity of similar data objects by invoking one or more of the data processing functionalities of the one or more enterprise software applications 135.

In some example embodiments, the task editor 115 may implement a low code or no code approach to the creation of the custom task. Accordingly, the task editor 115 may support the creation of the custom task with minimal requirement for coding. For example, the user interface 125 associated with the task editor 115 may be an interactive user interface in which a custom task is created based on one or more inputs from a user 140 at the client device 120. The one or more inputs from the user 140 may configured the custom task, for example, by adding one or more components to the task, reordering the one or more components, configuring the properties of the one or more components, and/or deleting the one or more components.

A custom task may be thought of as a sequence of actions, each of which having one or more inputs and outputs. The inputs and outputs of an action may be defined in a variety of ways. Defining an input or an output of an action as a fixed value may be less flexible as the fixed value may be applicable to a limited quantity of specific use cases. Alternatively, when defined as a variable whose value is subject to change based on one or more preceding actions and/or conditions, the resulting task may be capable of adapting to multiple situations. However, the value of some variables cannot be determined during the configuration of the custom task. Instead, the value of some variables are provided, for example, by the user 140 associated with the client device 120, during the execution of the task. User input, such as those providing the value of a variable during the execution of a custom task, may be solicited through a form. As such, in some example embodiments, the task editor 115 may also support the creation of forms graphically, for example, through the user interface 125, with minimal requirement for coding on the part of the user 140. These forms may be customizable and be able to accommodate a variety of types of inputs including, for example, text fields, check boxes, date pickers, combination boxes, dropdown menus, and/or the like. Moreover, these forms may need to be displayed in two different environments. For instance, when a form is used in a process, the form may be displayed in a transactional application used to process tasks associated with the one or more enterprise software applications 135. Alternatively, when the form is used in an automation, the form may be displayed as a pop-up window generated by a desktop agent.

As used herein, the term “automation” refers to a sequence of activities and logic controls (e.g., conditions, loops, and/or the like), including custom tasks, defined by the user. An automation can be executed by a desktop agent. The sequence of activities defined in an automation is executed synchronously, meaning that once the automation is started, it will end when the entire sequence of activities is executed. That is, the sequence of activities cannot include a pause or wait, such as for an input, a resumption command, or another trigger with significant time delay. Meanwhile, the term “process” refers to a sequence of automations, custom tasks, and logic control. While processes and automations exhibit some similarities, the main difference is that custom tasks used in a process are handled by an inbox application similar to an email application. This means the user will receive the custom task inside this inbox application, and process the custom task (e.g., fill the inputs, confirm or reject, and/or the like) via the inbox application. By adding this paradigm, a process could have a longer duration than an automation. A custom task is able to remain in the inbox application for some time before being processed. Once the custom task is handled, the process will resume and execute the remaining actions in the sequence of actions defined to be a part of the process.

As noted, in some example embodiments, the task editor 115 may support the creation of a custom task associated with the one or more enterprise software applications 135. Moreover, the user interface 125 associated with the task editor 115 may be an interactive user interface displayed at the client device 120 to support the creation of each custom task graphically and with minimal requirement for cording, for example, on the part of the user 140 at the client device 120. A custom task created through the task editor 115 may be deployed in a variety of execution contexts including, for example, as a part of a process or an automation. It should be appreciated that the runtime behavior of the custom task may be automatically adapted depending on the execution context of the custom task. For example, when the custom task is used within a process, the custom task may be displayed in a transactional application (e.g., used to process tasks associated with the one or more enterprise software applications 135) during its execution. Alternatively, when the custom task is used within an automation, the custom task may be displayed in a pop-up window by a desktop agent.

In some example embodiments, to support the creation of custom tasks, the user interface 125 associated with the task editor 115 may include three portions. The first portion of the user interface 125 may be a left panel displaying a list of components added to a custom task. The user 140 at the client device 120 may interact with the list, for example, by selecting a component included in the list to remove the component from the custom task. The second portion of the user interface 125 may be a center panel displaying the custom task that is currently being created. The user 140 at the client device 120 may interact with the components included in the custom task, for example, by selecting a component and/or dragging the component to reorder the components included in the custom task.

In some example embodiments, the third portion of the user interface 125 associated with the task editor 115 may be a right panel having multiple functionalities. First, the right panel may display a list of available components for customizing the custom task. The right panel may also display the inputs and/or outputs associated with the custom task. A view with some general options may also available in the right panel. When a component in in the custom task is selected, the right panel of the user interface 125 may be updated to display a list of properties that can be used to customize the component. It should be appreciated that these properties may be specific for each type of component. Moreover, the value of some properties can be set through input variables while some properties may output their value through output variables. To further illustrate, Table 1 below depicts examples of components that can be added to a custom task.

```
TABLE 1
Label:
It adds a standalone label with the following properties to inform the users:
  Text
  Text Alignment
  Wrapping
  Tooltip
Link:
It adds a link with the following properties:
  Text
  Href
Title:
It adds a title with the following properties:
  Text
Check Box:
It adds a check box that allows the users to check/uncheck an option.
The result is transmitted and can be used by the rest of the Automation
or Process. It has the following properties:
  Label
  Text
  Enabled
  Selected
  Wrapping
Combo Box and Multi-combo Box:
It adds a combo box or a Multi-combo Box, it allows users to make a
choice between multiple options. They have the following properties:
  Label
  List
  Default value
  Enabled
  Selected value (Combo-box)/Selected values (Multi-combo box)
Date Picker, Date/Time Picker and Time Picker:
It allows the users to select a Date, a Date/Time, or a Time. They
have the following properties:
  Label
  Placeholder
  Minimum date, date/time
  Maximum date, date/time
  Minutes step (Date/Time and Time Picker)
  Seconds step (Date/Time and Time Picker)
  Initial focused date, date/time
  Display format (Date/Time and Time Picker)
  Required
  Enabled
  Show footer (Date picker)
  Date, Date/Time, Time value
Input:
It allows the users to enter an input to be used in the
Automation/Process. It has the following properties:
  Label
  Placeholder
  Description
  Format
  Required
  Enabled
  Value
Password input:
It allows users to enter a password. It has the following properties:
  Label
  Placeholder
  Description
  Required
  Enabled
  Value
File picker: (This component is compatible with automations)
It allows the users to select a file available in the local machine.
The file then can be used by the automation. The file picker has the
following properties:
  Label
  Placeholder
  Text button
  File path
```

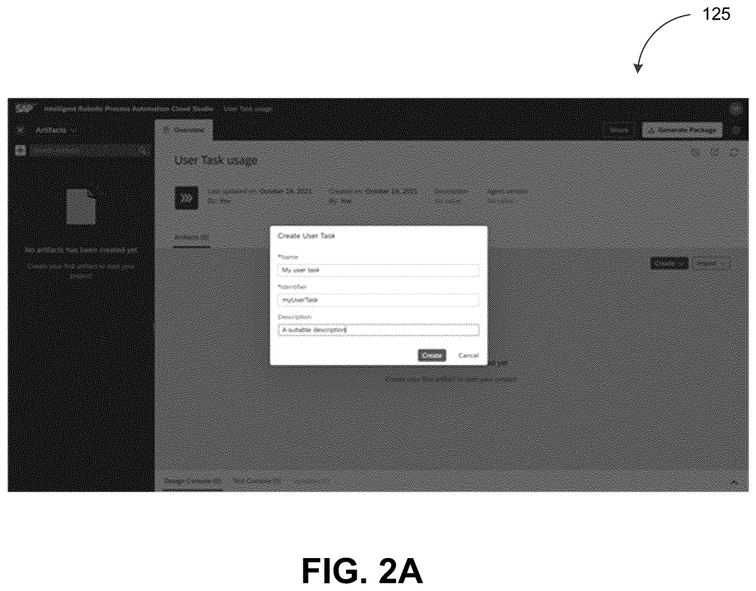

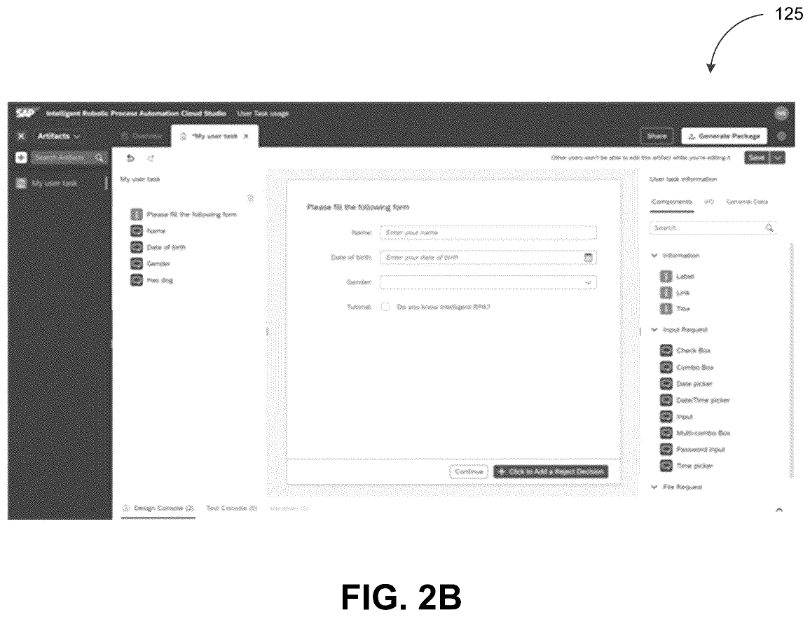

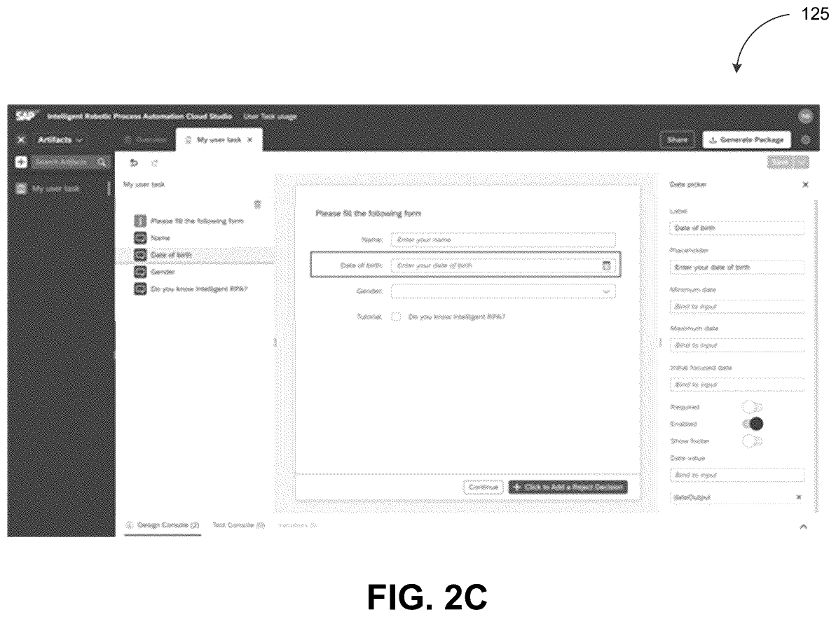

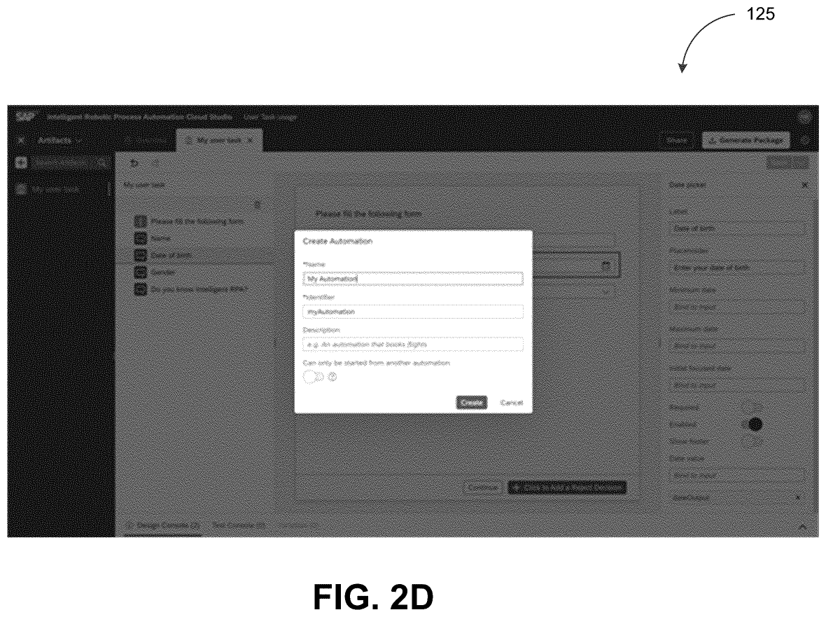

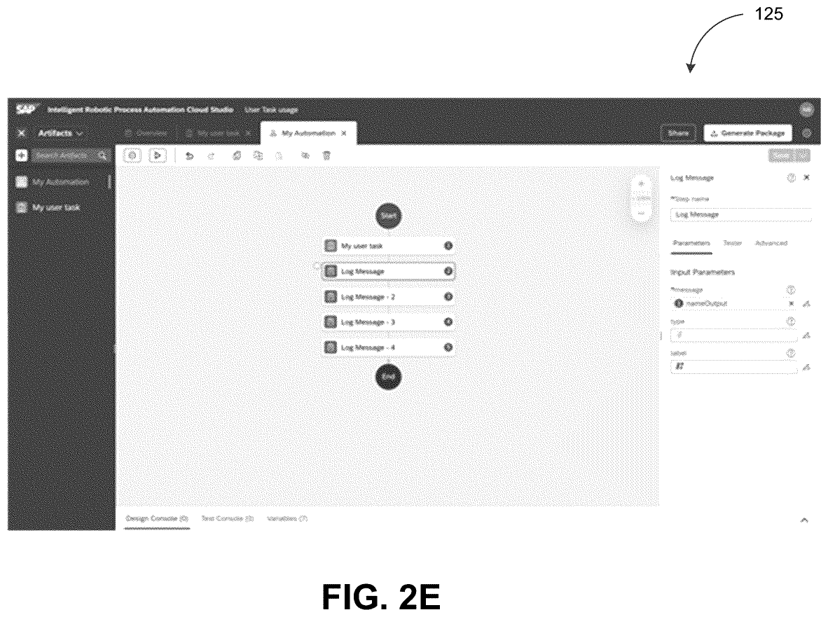

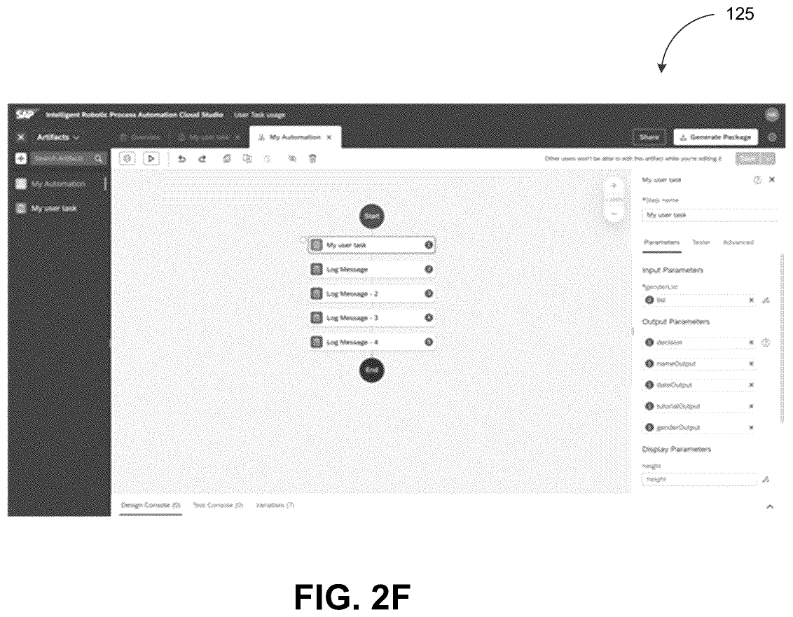

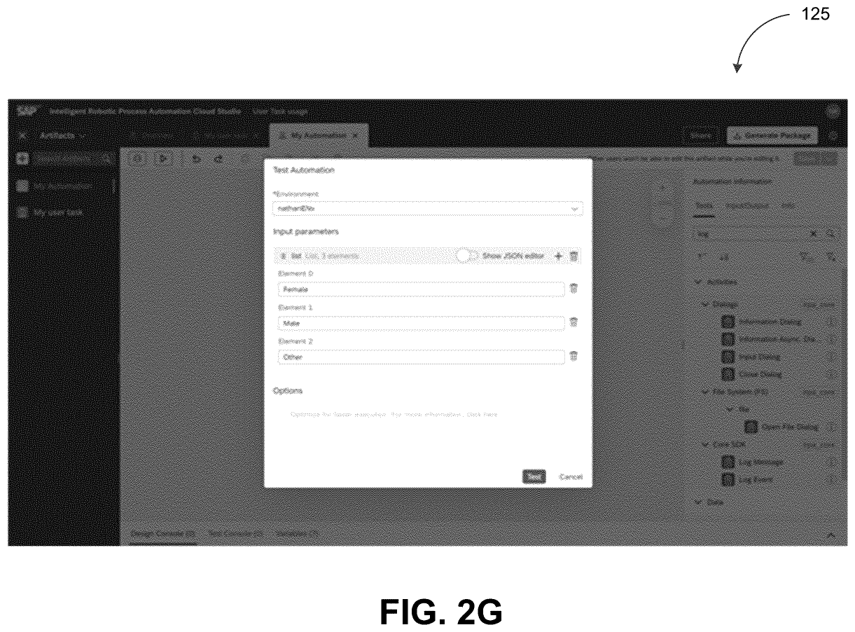

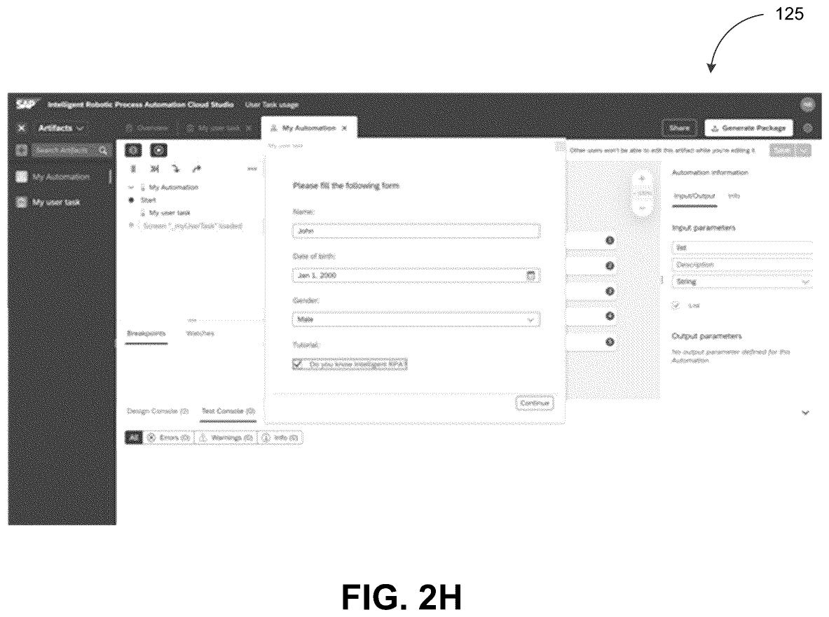

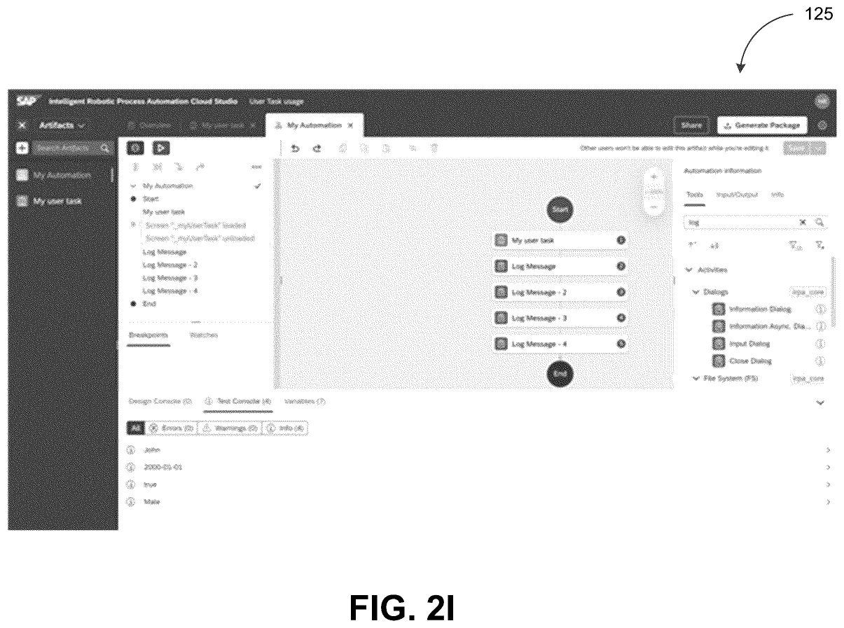

FIGS. 2A-I depict examples of the user interface 125 for creating a custom task, in accordance with some example embodiments. According to some example embodiments, the examples of the user interface 125 shown in FIGS. 2A-I may be displayed at the client device 120 to receive, for example, from the user 140, one or more inputs for creating a custom task. Referring first to FIG. 2A, the example of the user interface 125 shown in FIG. 2A may receive one or more inputs for creating a new custom task. FIGS. 2B-C depicts examples of the user interface 125 in which the components shown in Table 2 below are added to the custom task before being saved.

TABLE 2

```
Title:
  Text: “Please fill the following form”
Input:
  Label: “Name”
  Placeholder: “Enter your name”
  Value output: create a variable named nameOutput
Date picker:
  Label: “Date of birth”
  Placeholder: “Enter your date of birth”
  Date value output: create a variable named dateOutput
Combo box:
  Label: “Gender”
  List: create a variable named genderList
  Selected value: create a variable named genderOutput
Check box:
  Label: “Tutorial”
  Text: “Do you know Intelligent RPA”
  Selected output: create a variable named tutorialOutput
```

Referring now to FIG. 2D, the example of the user interface 125 shown in FIG. 2D may be configured to receive one or more inputs for creating a new automation. FIG. 2E depicts an example of the user interface 125 configured to receive one or more user inputs for adding the custom task to the automation along with one or more activities. For instance, in the example shown in FIG. 2E, the custom task is added to the automation along with four “log message” activities to display the outputs of the custom task (e.g., in a test console). For each “log message activity,” one or more outputs of the custom task may be added as an input parameter. The example of the user interface 125 shown in FIG. 2F shows the custom task being selected and a variable named “list” being created in the “genderList” input field before the automation is saved. FIG. 2G shows an example of the user interface configured to receive one or more inputs to execute the automation along with the values “Female,” “Male,” and “Other.”

FIG. 2H depicts an example of the user interface 125 in which a form soliciting for certain values is displayed as a pop-up window. Upon inputting the values for “Name,” “Date of Birth,” and “Gender,” the custom task may continue its execution. These values may be visualized in the text console displayed in the example of the user interface 125 shown in FIG. 2I.

In some example embodiments, a custom task created via the user interface 125 associated with the task editor 115 may be defined as a corresponding custom task object. The custom task object may be defined based on two main properties, e.g., an Extensible Markup Language (XML) view and bindings. Additional metadata may be stored but may be irrelevant for the functionality of the custom task. Accordingly, at design time, the task editor 115 may modify the Extensible Markup Language (XML) view of a custom task object and add new bindings based on one or more inputs received through the user interface 125, for example, from the user 140 at the client device 120. The Extensible Markup Language (XML) view of the custom task object may include a variety of application framework components such as OpenUIS or other JavaScript application framework components. Table 3 below depicts the structure of an Extensible Markup Language (XML) view of a custom task.

TABLE 3

```
<Panel>
  <Form>
    ...
    <FormContainer>
      <FormElement>
        <fields>
          {UI5 component listed in the component list}
        </fields>
      </FormElement>
    </FormContainer>
    ...
  </Form>
</Panel>
```

A form may be constructed through interactions with the user interface 125 associated with the task editor 115. These interactions may correspond to adding, reordering, and deleting FormContainers containing specific application framework (e.g., OpenUIS) components in the Extensible Markup Language (view) with programming code (e.g., JavaScript and/or the like). From the perspective of the user 140, the user 140 is able to create and customize forms with minimal requirement for coding. form.

To customize the content of a particular component within the custom task, one or more properties of the component may be directly modified in the Extensible Markup Language (XML) view of the custom task if the selected value is a constant or fixed value. In the event the selected value of a variable, a binding may be created to link the component's property to the variable. Each component can provide an output that can be linked to an output of the custom task for use in workflows.

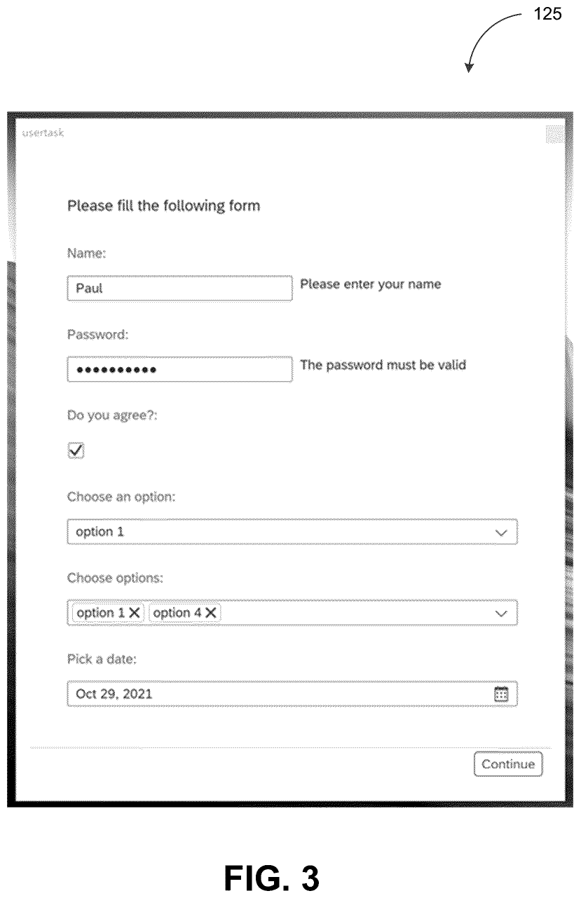

As noted, the runtime display of the custom task may be handled either by a transactional application used to process tasks associated with the one or more enterprise software applications 135 or by a desktop agent. FIG. 3 depicts a screenshot illustrating an example of the user interface 125 associated with a desktop agent opening the custom task during the execution of a corresponding automation. In either instance, a standalone component (e.g., a JavaScript component) may be used to display the custom task at runtime, thus allowing the same programming code to be reused for both. This component may take the Extensible Markup Language (XML) view of the custom task and links every bindings to the properties with the function bindProperty( ). The outputs of the custom task are then returned by the component after the execution of the custom task.

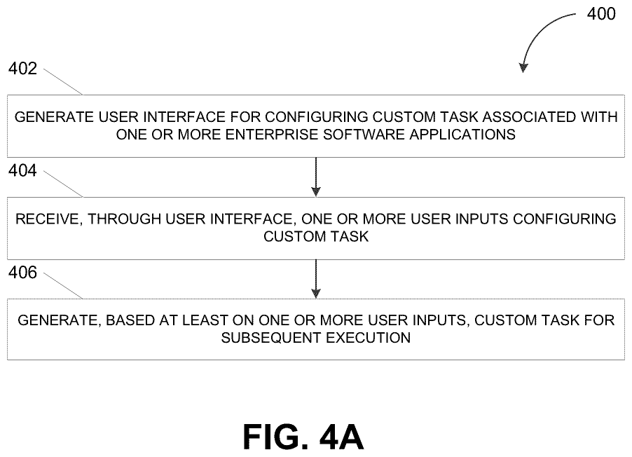

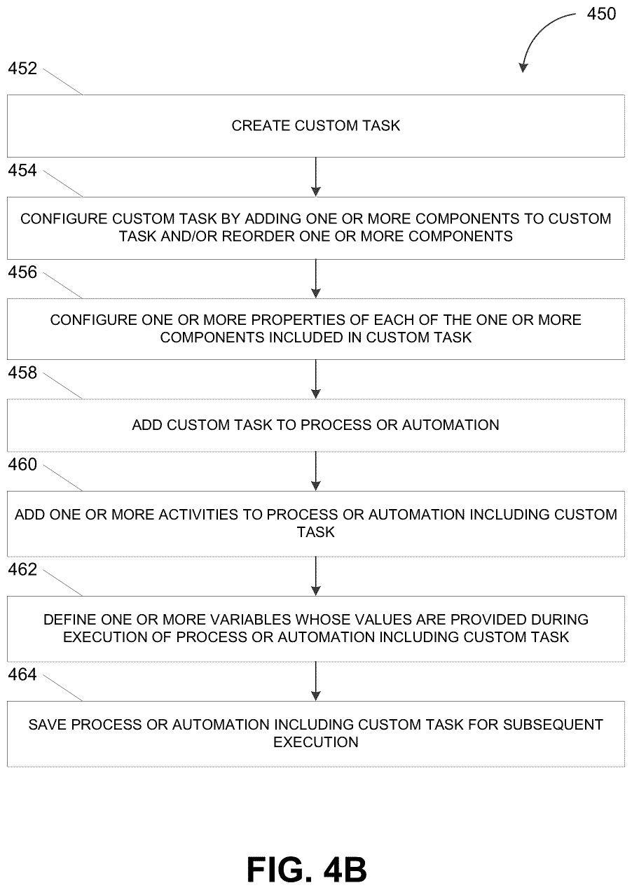

FIG. 4A depicts a flowchart illustrating an example of a process 400 for creating a custom task, in accordance with some example embodiments. Referring to FIGS. 1-3 and 4A, the process 400 may be performed by the custom task controller 110, for example, the task editor 115, to create a custom task associated with one or more enterprise software applications 135 hosted at the enterprise backend 130. In some example embodiments, the custom task may automate a variety of operations associated with the one or more enterprise software applications 135 including, for example, billing, invoicing, procurement, payroll, time and attendance management, recruiting and onboarding, learning and development, performance and compensation, workforce planning, logistics, and/or the like.

At 402, the task editor 115 may generate a user interface for configuring a custom task associated with one or more enterprise software applications. For example, the task editor 115 may generate the user interface 125, which may be displayed at the client device 120 for receiving one or more user inputs configuring a custom task associated with the one or more enterprise software applications 135 hosted at the enterprise backend 130. The user interface 125 may be an interactive user interface that supports the creation and configuration of the custom task through, for example, adding one or more components to the task, reordering the one or more components, configuring the properties of the one or more components, and/or deleting the one or more components. As noted, according to some example embodiments, the task editor 115 may support the creation and configuration of the custom task graphically, for example, through the user interface 125, with minimal requirement for coding on the part of the user 140.

At 404, the task editor 115 may receive, through the user interface, one or more user inputs configuring the custom task. In some example embodiments, the task editor 115 may receive, through the user interface 125 displayed at the client device 120, one or more user inputs for configuring the custom task, for example, by adding one or more components to the task, reordering the one or more components, configuring the properties of the one or more components, deleting the one or more components, and/or the like.

At 406, the task editor 115 may generate, based at least on the one or more user inputs, the custom task for subsequent execution. For example, upon configuring the custom task as well as the automation or process including the custom task, the task editor 115 may create and save the automation or process including the custom task for subsequent execution.

FIG. 4B depicts a flowchart illustrating another example of a process 450 for creating a custom task, in accordance with some example embodiments. Referring to FIGS. 1-3 and 4B, the process 450 may be performed by the custom task controller 110, for example, the task editor 115, to create a custom task associated with one or more enterprise software applications 135 hosted at the enterprise backend 130. In some example embodiments, the custom task may automate a variety of operations associated with the one or more enterprise software applications 135 including, for example, billing, invoicing, procurement, payroll, time and attendance management, recruiting and onboarding, learning and development, performance and compensation, workforce planning, logistics, and/or the like.

At 452, the task editor 115 may create a custom task. For example, as shown in FIG. 2A, the task editor 115 may receive, through the user interface 125 displayed at the client device 120, one or more user inputs creating a custom task associated with the one or more enterprise software application 135. In the example of the user interface 125 shown in FIG. 2A, the custom task may be created based on one or more user inputs specifying a name and a description for the custom task. In some cases, the task editor 115 may assign, based on the specified name of the custom task, an identifier for the custom task. It should be appreciated that the identifier assigned to the custom task may remain fixed even as the name of the custom task undergo subsequent changes. Moreover, the identifier for the custom task may be unique to enable a differentiation between different custom tasks associated with the one or more enterprise software application 135.

At 454, the task editor 115 may configure the custom task by adding one or more components to the custom task and/or reordering the one or more components. In some example embodiments, the task editor 115 may support the creation of the custom task with minimal requirement for coding. Accordingly, the custom task may be configured based on one or more user inputs, for example, received from the user interface 125 displayed at the client device 125, adding one or more components to the task, reordering the one or more components, configuring the properties of the one or more components, and/or deleting the one or more components. As shown in FIGS. 2B-C, the user interface 125 for configuring the custom task may include a first portion (e.g., a left panel) displaying a list of components added to the custom task, a second portion (e.g., a center panel) that allows for the reordering of the components included in the custom task, and a third portion (e.g., a right panel) displaying a list of available components for customizing the custom task, inputs and/or outputs associated with the custom task, and a list of properties that can be used to customize one or more select components of the custom task.

At 456, the task editor 115 may configure one or more properties of each of the one or more components included in the custom task. In some example embodiments, each component added to the custom task may be associated with one or more component-specific properties. The value of some properties may be set through input variables while some properties may output their value through output variables. As noted, a variable may be an input value or an output value of an action corresponding to a component within the custom task whose value is determined at runtime, for example, based on one or more preceding actions (e.g., components) and/or conditions within the custom task. Configuring the properties of a component in the custom task may therefore include linking each property of the custom task to an input variable and/or an output variable of one or more components within the custom task.

At 458, the task editor 115 may add the custom task to an automation or a process. In some example embodiments, the custom task may be deployed as a part of a process, in which case the execution of the custom task may be handled by a transactional application used to process tasks associated with the one or more enterprise software applications 135. Alternatively, the custom task may be deployed as a part of an automation, in which case a desktop agent may handle the execution of the custom task. Accordingly, the task editor 115 may, based at least on one or more user inputs received through the user interface 125 displayed at the client device 120, add the custom task to either an automation (e.g., as shown in FIG. 2D) or a process. In either instance, to enable reuse of the same programming code, a standalone component (e.g., a JavaScript component) may be used to display the custom task at runtime.

At 460, the task editor 115 may add one or more activities to the automation or process including the custom task. For example, as shown in FIGS. 2E-F, one or more activities may be added to the automation or process including the custom task. In the example shown in FIGS. 2E-F, a custom task is added to an automation along with four “log message” activities to display the outputs of the custom task (e.g., in a test console). Accordingly, for each “log message activity,” one or more outputs of the custom task may be added as an input parameter.

At 462, the task editor 115 may define one or more variables whose values are provided during an execution of the automation or process including the custom task. As noted, in some example embodiments, the value of some variables associated with the custom task are not determined during the configuration of the custom task but are instead provided, for example, by the user 140 associated with the client device 120, during the execution of the custom task. User input, such as those providing the value of a variable during the execution of a custom task, may be solicited through a form. Accordingly, the task editor 115 may also support the creation of forms graphically, for example, through the user interface 125, with minimal requirement for coding on the part of the user 140. As is the case with the custom task itself, when a form soliciting the value of a variable associated with the custom task is used in a process, the form may be displayed in a transactional application used to process tasks associated with the one or more enterprise software applications 135. Alternatively, when the form is used in an automation, the form may be displayed as a pop-up window generated by a desktop agent.

At 464, the task editor 115 may save the automation or process including the custom task for subsequent execution. For example, upon configuring the custom task as well as the automation or process including the custom task, the automation or process may be saved for subsequent execution. FIGS. 2G-I depicts one example in which the user interface 125 associated with the task editor 115 receives one or more user inputs (e.g., input parameters) for testing an automation including the custom task. As shown in FIG. 2I, the values of the output variables associated with the custom task may be displayed in the test console included in the user interface 125 of the task editor 115.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1: A system, comprising: at least one data processor; and at least one memory storing instructions, which when executed by the at least one data processor, result in operations comprising: generating, for display at a client device, a user interface for creating and configuring a custom task associated with one or more enterprise software applications, the user interface displaying a plurality of components, and the custom task being configurable by adding one or more components to the custom task, reordering the one or more components, configuring a property of the one or more components, and/or deleting the one or more components from the custom task; receiving, through the user interface, one or more user inputs configuring the custom task; and generating, based on the one or more user inputs, the custom task for subsequent execution.

Example 2: The system of Example 1, wherein the custom task comprises a sequence of actions corresponding to the one or more components added to the custom task, and wherein each action in the sequence of actions is associated with one or more inputs and/or outputs.

Example 3: The system of Example 2, wherein at least one input or output of the one or more inputs and/or outputs is defined as a fixed value.

Example 4: The system of any one of Examples 2 to 3, wherein at least one input or output of the one or more inputs and/or outputs is defined as a variable.

Example 5: The system of Example 4, wherein the variable is associated with a value that is provided during an execution of the custom task.

Example 6: The system of Example 5, wherein the operations further comprise: updating the user interface to support creating and configuring a form for soliciting one or more user inputs specifying the value of the variable during the execution of the custom task.

Example 7: The system of any one of Examples 1 to 6, wherein the operations further comprise: updating the user interface to support creating and configuring an automation or process; receiving, through the updated user interface, a first user input creating the automation or process; receiving, through the updated user interface, a second user input adding the custom task to the automation or process; and generating, based at least on the first user input and the second user input, the automation or process including the custom task.

Example 8: The system of Example 7, wherein the operations further comprise: receiving, through the updated user interface, a third user input adding one or more activities to the automation or process including the custom task; and generating, based at least on the third user inputs, the automation or process to include the custom task as well as the one or more activities.

Example 9: The system of Example 8, wherein the one or more activities include a log message activity for displaying an output of the custom task.

Example 10: The system of any one of Examples 1 to 9, wherein the generating of the custom task includes generating a corresponding custom task object having an Extensible Markup Language (XML) view and one or more bindings.

Example 11: The system of Example 10, wherein the custom task is configured by at least modifying the Extensible Markup Language (XML) view of the custom task.

Example 12: The system of any one of Examples 10 to 11, wherein the one or more bindings are created in response to a component in the custom task being linked to a variable input or a variable output.

Example 13: A computer-implemented method, comprising: generating, for display at a client device, a user interface for creating and configuring a custom task associated with one or more enterprise software applications, the user interface displaying a plurality of components, and the custom task being configurable by adding one or more components to the custom task, reordering the one or more components, configuring a property of the one or more components, and/or deleting the one or more components from the custom task; receiving, through the user interface, one or more user inputs configuring the custom task; and generating, based on the one or more user inputs, the custom task for subsequent execution.

Example 14: The method of Example 13, wherein the custom task comprises a sequence of actions corresponding to the one or more components added to the custom task, wherein each action in the sequence of actions is associated with one or more inputs and/or outputs, and wherein the one or more inputs and/or outputs are defined as a fixed value or a variable associated with a value that is provided during an execution of the custom task.

Example 15: The method of any one of Examples 13 to 14, further comprising: updating the user interface to support creating and configuring an automation or process; receiving, through the updated user interface, a first user input creating the automation or process; receiving, through the updated user interface, a second user input adding the custom task to the automation or process; and generating, based at least on the first user input and the second user input, the automation or process including the custom task.

Example 16: The method of Example 15, further comprising: receiving, through the updated user interface, a third user input adding one or more activities to the automation or process including the custom task; and generating, based at least on the third user inputs, the automation or process to include the custom task as well as the one or more activities.

Example 17: The method of any one of Examples 13 to 16, wherein the generating of the custom task includes generating a corresponding custom task object having an Extensible Markup Language (XML) view and one or more bindings.

Example 18: The method of Example 17, wherein the custom task is configured by at least modifying the Extensible Markup Language (XML) view of the custom task.

Example 19: The method of Example 18, wherein the one or more bindings are created in response to a component in the custom task being linked to a variable input or a variable output.

Example 20: A non-transitory computer readable medium storing instructions, which when executed by at least one data processor, result in operations comprising: generating, for display at a client device, a user interface for creating and configuring a custom task associated with one or more enterprise software applications, the user interface displaying a plurality of components, and the custom task being configurable by adding one or more components to the custom task, reordering the one or more components, configuring a property of the one or more components, and/or deleting the one or more components from the custom task; receiving, through the user interface, one or more user inputs configuring the custom task; and generating, based on the one or more user inputs, the custom task for subsequent execution.

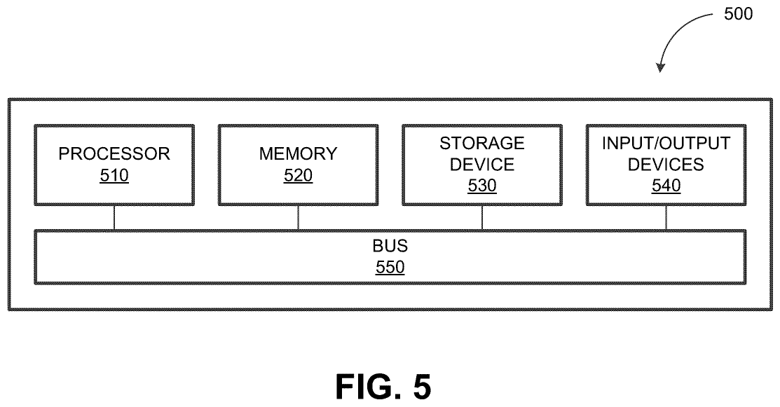

FIG. 5 depicts a block diagram illustrating a computing system 500, in accordance with some example embodiments. Referring to FIGS. 1-5, the computing system 500 can be used to implement the custom task controller 110 and/or any components therein.

As shown in FIG. 5, the computing system 500 can include a processor 510, a memory 520, a storage device 530, and input/output devices 540. The processor 510, the memory 520, the storage device 530, and the input/output devices 540 can be interconnected via a system bus 550. The processor 510 is capable of processing instructions for execution within the computing system 500. Such executed instructions can implement one or more components of, for example, the custom task controller 110. In some implementations of the current subject matter, the processor 510 can be a single-threaded processor. Alternately, the processor 510 can be a multi-threaded processor. The processor 510 is capable of processing instructions stored in the memory 520 and/or on the storage device 530 to display graphical information for a user interface provided via the input/output device 540.

The memory 520 is a computer readable medium such as volatile or non-volatile that stores information within the computing system 500. The memory 520 can store data structures representing configuration object databases, for example. The storage device 530 is capable of providing persistent storage for the computing system 500. The storage device 530 can be a floppy disk device, a hard disk device, an optical disk device, or a tape device, or other suitable persistent storage means. The input/output device 540 provides input/output operations for the computing system 500. In some implementations of the current subject matter, the input/output device 540 includes a keyboard and/or pointing device. In various implementations, the input/output device 540 includes a display unit for displaying graphical user interfaces.

According to some implementations of the current subject matter, the input/output device 540 can provide input/output operations for a network device. For example, the input/output device 540 can include Ethernet ports or other networking ports to communicate with one or more wired and/or wireless networks (e.g., a local area network (LAN), a wide area network (WAN), the Internet).

In some implementations of the current subject matter, the computing system 500 can be used to execute various interactive computer software applications that can be used for organization, analysis and/or storage of data in various (e.g., tabular) format (e.g., Microsoft Excel®, and/or any other type of software). Alternatively, the computing system 500 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 540. The user interface can be generated and presented to a user by the computing system 500 (e.g., on a computer screen monitor, etc.).

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. For example, the logic flows may include different and/or additional operations than shown without departing from the scope of the present disclosure. One or more operations of the logic flows may be repeated and/or omitted without departing from the scope of the present disclosure. Other implementations may be within the scope of the following claims.

What is claimed is:

1. A system, comprising:
at least one data processor; and
at least one memory storing instructions which, when executed by the at least one data processor, result in operations comprising:
generating, for display at a client device, a user interface for creating and configuring a custom task associated with one or more enterprise software applications, the user interface displaying a plurality of components, and the custom task being configurable by adding one or more components to the custom task, reordering the one or more components, configuring a property of the one or more components, and/or deleting the one or more components from the custom task;
receiving, through the user interface, one or more user inputs configuring the custom task; and
generating, based on the one or more user inputs, the custom task for subsequent execution.

2. The system of claim 1, wherein the custom task comprises a sequence of actions corresponding to the one or more components added to the custom task, and wherein each action in the sequence of actions is associated with one or more inputs and/or outputs.

3. The system of claim 2, wherein at least one input or output of the one or more inputs and/or outputs is defined as a fixed value.

4. The system of claim 2, wherein at least one input or output of the one or more inputs and/or outputs is defined as a variable.

5. The system of claim 4, wherein the variable is associated with a value that is provided during an execution of the custom task.

6. The system of claim 5, wherein the operations further comprise:
updating the user interface to support creating and configuring a form for soliciting one or more user inputs specifying the value of the variable during the execution of the custom task.

7. The system of claim 1, wherein the operations further comprise:
updating the user interface to support creating and configuring an automation or process;
receiving, through the updated user interface, a first user input creating the automation or process;
receiving, through the updated user interface, a second user input adding the custom task to the automation or process; and
generating, based at least on the first user input and the second user input, the automation or process including the custom task.

8. The system of claim 7, wherein the operations further comprise:
receiving, through the updated user interface, a third user input adding one or more activities to the automation or process including the custom task; and
generating, based at least on the third user inputs, the automation or process to include the custom task as well as the one or more activities.

9. The system of claim 8, wherein the one or more activities include a log message activity for displaying an output of the custom task.

10. The system of claim 1, wherein the generating of the custom task includes generating a corresponding custom task object having an Extensible Markup Language (XML) view and one or more bindings.

11. The system of claim 10, wherein the custom task is configured by at least modifying the Extensible Markup Language (XML) view of the custom task.

12. The system of claim 10, wherein the one or more bindings are created in response to a component in the custom task being linked to a variable input or a variable output.

13. A computer-implemented method, comprising:
generating, for display at a client device, a user interface for creating and configuring a custom task associated with one or more enterprise software applications, the user interface displaying a plurality of components, and the custom task being configurable by adding one or more components to the custom task, reordering the one or more components, configuring a property of the one or more components, and/or deleting the one or more components from the custom task;
receiving, through the user interface, one or more user inputs configuring the custom task; and
generating, based on the one or more user inputs, the custom task for subsequent execution.

14. The method of claim 13, wherein the custom task comprises a sequence of actions corresponding to the one or more components added to the custom task, wherein each action in the sequence of actions is associated with one or more inputs and/or outputs, and wherein the one or more inputs and/or outputs are defined as a fixed value or a variable associated with a value that is provided during an execution of the custom task.

15. The method of claim 13, further comprising:
updating the user interface to support creating and configuring an automation or process;
receiving, through the updated user interface, a first user input creating the automation or process;
receiving, through the updated user interface, a second user input adding the custom task to the automation or process; and
generating, based at least on the first user input and the second user input, the automation or process including the custom task.

16. The method of claim 15, further comprising:
receiving, through the updated user interface, a third user input adding one or more activities to the automation or process including the custom task; and
generating, based at least on the third user inputs, the automation or process to include the custom task as well as the one or more activities.

17. The method of claim 13, wherein the generating of the custom task includes generating a corresponding custom task object having an Extensible Markup Language (XML) view and one or more bindings.

18. The method of claim 17, wherein the custom task is configured by at least modifying the Extensible Markup Language (XML) view of the custom task.

19. The method of claim 18, wherein the one or more bindings are created in response to a component in the custom task being linked to a variable input or a variable output.

20. A non-transitory computer readable medium storing instructions, which when executed by at least one data processor, result in operations comprising:
generating, for display at a client device, a user interface for creating and configuring a custom task associated with one or more enterprise software applications, the user interface displaying a plurality of components, and the custom task being configurable by adding one or more components to the custom task, reordering the one or more components, configuring a property of the one or more components, and/or deleting the one or more components from the custom task;
receiving, through the user interface, one or more user inputs configuring the custom task; and
generating, based on the one or more user inputs, the custom task for subsequent execution.
